(19) United States
(12) Patent Application Publication
(10) Pub. No.: US 2011/0229334 A1
(43) Pub. Date: Sep. 22, 2011

(54) COMPOSITE LEADING EDGE SHEATH AND DOVETAIL ROOT UNDERCUT

(75) Inventor: Phillip Alexander, Colchester, CT (US)

(73) Assignee: UNITED TECHNOLOGIES CORPORATION, Hartford, CT (US)

(21) Appl. No.: 12/724,626

(22) Filed: Mar. 16, 2010

(51) Int. Cl. F01D 5/14; B23P 6/00

(52) U.S. Cl. 416/224; 29/889.1

(57) ABSTRACT

An airfoil having a composite blade formed from a plurality of plies and having a leading edge and a root for attachment to an engine. The blade has a decreased number of plies at the junction of the blade leading edge and the root. A metallic sheath is attached to the leading edge, wherein the sheath has a portion proximate the junction of sufficient thickness to restore at least a portion of the decreased number of plies

### BACKGROUND

Composite materials offer potential design improvements in gas turbine engines. For example, in recent years composite materials have been replacing metals in gas turbine engine fan blades because of their high strength and low weight. Most metal gas turbine engine fan blades have been made from titanium. The ductility of titanium fan blades enables the fan to ingest a bird and remain operable or be safely shut down. The same requirements are present for composite fan blades.

A composite airfoil for a turbine engine fan blade can have a sandwich construction with a carbon fiber woven core at the center and two-dimensional filament reinforced plies or laminations on either side. To form the composite airfoil, individual two-dimensional plies are cut and stacked in a mold with the woven core. The mold is injected with a resin using a resin transfer molding process and cured. The plies vary in length and shape. The carbon fiber woven core is designed to accommodate ply drops so that multiple plies do not end at the same location.

Previous composite blades have been configured to improve the impact strength of the composite airfoils so they can withstand bird strikes. During use, foreign objects ranging from large birds to hail may be entrained in the inlet of the gas turbine engine. Impact of large foreign objects can rupture or pierce the blades and cause secondary damage downstream of the blades.

In order to prevent damage from the impact of foreign objects such as birds, a metallic sheath has been used to protect the leading edge of rotor blades and propellers made from composites. Materials such as titanium and nickel alloys have been fitted on the leading edge of the element to be protected. Examples of sheaths used for covering and protecting a component leading edge of an airfoil component are disclosed in U.S. Pat. No. 5,881,972 and U.S. Pat. No. 5,908,285. In both patents, the sheaths are formed from metal that is electroformed on the airfoil component on a mandrel. The sheath and mandrel are separated and the sheath is mounted on the airfoil.

In more recent years, sheaths have been bonded on a molded composite blade by forming the blade, usually in a resin transfer molding (RTM) process. Once the blade has been formed, an adhesive is placed on the leading edge and a leading edge sheath is placed against the adhesive, heat and pressure are applied and the adhesive cures to mount the leading edge as needed. While this process is costly, it is also effective in producing airfoils capable of withstanding impact by birds and other debris that might otherwise damage or destroy the airfoil.

During the event of a bird strike making contact with or impacting on a fan blade, one area that generally experiences significant stress and strain is the leading edge root area of the airfoil. A reason for the location of this area of concern is that there is a relatively significant change in the thickness as the area begins transitioning from the blade to the attachment region or root of the blade. This is of particular concern when the airfoil is a composite airfoil having multiple plies through the thickness of the blade. Local stress concentration is aggravated by ply drops that are required to form the transitioning decrease in thickness. These local ply drops and high stresses induce an early de-lamination failure in the part.

### SUMMARY

A composite airfoil having a leading edge, a trailing edge, a tip, a root, a suction side and a pressure side includes a metallic sheath sized at the point where the composite material undergoes a thickness decrease as the airfoil is joined to its root. The sheath includes additional metal to compensate for the decrease in composite thickness. A portion of the composite material being covered by the sheath at this region can be removed to compensate for the added weight of the thicker portion of the sheath.

### BRIEF DESCRIPTION OF THE DRAWINGS

FIG. 1 is a side view of the airfoil and root of the present invention.

FIGS. 2a and 2b are section views of lines A-A and B-B of FIG. 1 respectively.

FIG. 3 is a side view of an airfoil having the sheath of this invention in place.

FIGS. 4a and 4b are section views of lines C-C and D-D of FIG. 3 respectively.

### DETAILED DESCRIPTION

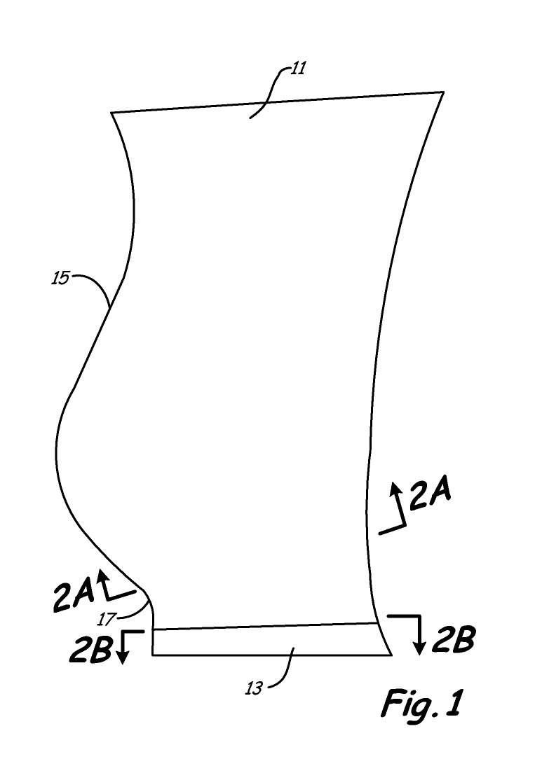

FIG. 1 illustrates a conventional airfoil 11 that has a root 13 and leading edge 15. Airfoils 11 may be made of metal or other materials. A method of fabricating an airfoil made from a composite blade 11 is disclosed in a U.S. patent application titled Core Driven Ply Shape Composite Fan Blade and Method of Making, filed Nov. 30, 2009, having Ser. No. 12/627,629, which is incorporated herein by reference in its entirety.

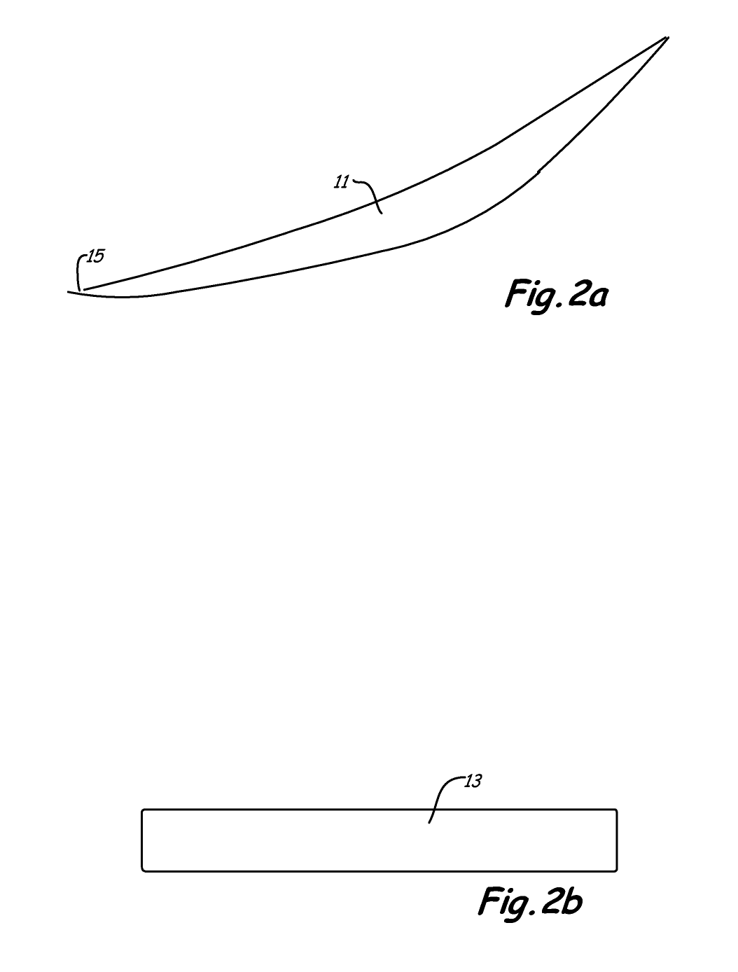

FIG. 2a is a cross sectional view of the area of blade 11 at line A-A of FIG. 1, which shows the thickness of leading edge 15 at that point 17 where leading edge 15 joins root 13 and FIG. 2b shows the thickness of root 13. Specifically, the width of root 13 is about 25 mm compared to leading edge 15 thickness of about 0.5 mm. This is a significant change in thickness in a short distance. Clearly this point 17 of leading edge 15 of airfoil 11 at root 13 is significantly weaker than the rest of the blade. Impact by an object such as a bird, ice or other debris on any part of the leading edge 15 will put substantial stress on area 17 and may cause failure of airfoil 11 at that thinnest point.

In composite blades which have a woven core and a plurality of plies completing the composite, the plies removed at area 17 significantly change the strength at this location. The number of plies that make up just one inch (25.4 mm) of thickness is in the 100s.

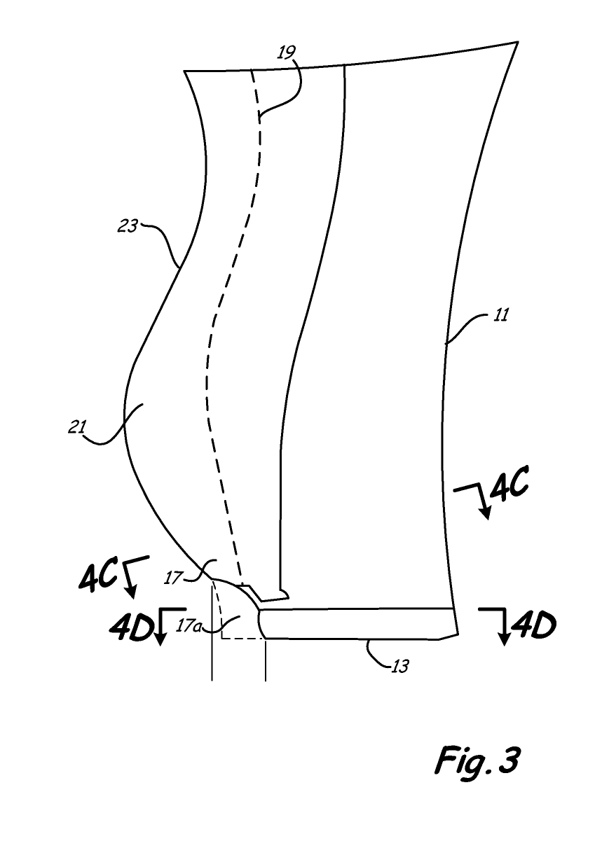

In order to protect weak area 17 in accordance with this invention as seen in FIG. 3, the leading edge root of blade 11 is cut back 17a so that the leading edge of the composite airfoil 19 intersects the leading edge 23 of sheath 21 at a point of greater thickness.

Sheath 21 may be made from any of the conventional materials. For example, sheath 21 can be made from any hard material, such as titanium and nickel sheaths, and those made from alloys of these metals.

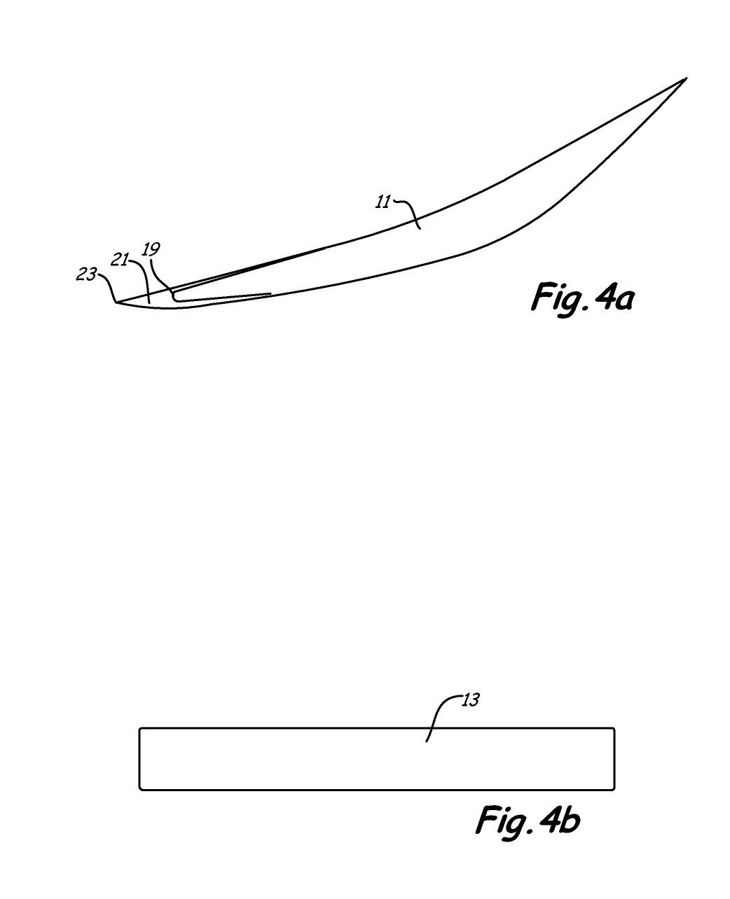

FIG. 4a is a cross sectional view of the area of blade 11 of FIG. 3 at line C-C which shows the increase in thickness of the composite leading edge 19 relative to the actual leading edge 23 of the sheath 21. FIG. 4b shows the thickness of the root 13 at line D-D of FIG. 3, which remains 1 inch (or 25.mm). The decrease in chord length of the composite leading edge 19 is compensated by at least a portion of the leading edge 23 of the metal sheath 21. Preferably the leading edge 23 of sheath 21 is of sufficient chord length to restore the airfoil to it original shape. The thickness of leading edge 19 is directly proportional to the amount of cutback material 17a and the length of the metal sheath leading edge. If the leading edge of the airfoil is such that the thickness is decreased from about 25 mm in the root to 0.5 mm at the airfoil, the combined effect of the cutback 17a and leading edge 23 of sheath 21 will increase the thickness of the composite 19 from 0.5 mm to about 10 mm.

The use of a sheath to protect an airfoil is accomplished in the same manner that sheaths are attached to airfoil blades. One method is to apply an epoxy adhesive such as, by way of example and not as a limitation, Hysol EA9393 to the leading edge 19 and bond sheath 21 thereto by applying heat to cure the adhesive. A primer may also be used prior to application of the adhesive. The present invention is intended for use with any rotating blade that includes a root that has a decreased area that dovetails into the blade itself.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An airfoil device comprising:
an airfoil having a composite blade formed from a plurality of plies and having a leading edge and a root for attachment to an engine;
the blade having a decreased thickness of plies at the junction of the blade leading edge and the root; and
a metallic sheath attached to the leading edge of the blade, the sheath having a portion proximate the junction of the leading edge and root of sufficient thickness to restore at least a portion of the decreased thickness of plies.

2. The device of claim 1, wherein the sheath is made from a metal selected from titanium, nickel and alloys thereof.

3. The device of claim 1, wherein the portion proximate the junction of the leading edge and root restores the substantially all the decreased number of plies.

4. The device of claim 3, wherein the decreased number of plies is about 25 mm.

5. The device of claim 4, wherein the decreased number of plies is a decrease from 25 mm to about 0.5 mm and the portion of the sheath proximate the decreased number of plies is from about 12 to 25 mm.

6. In an airfoil device having an airfoil having a composite blade formed from a plurality of plies and having a leading edge and a root for attachment to an engine; and the blade has a decreased number of plies at the junction of the blade leading edge and the root; the improvement comprising:
a metallic sheath attached to the leading edge of the blade, the sheath having a portion proximate the junction of the leading edge and root of sufficient thickness to restore at least a portion of the decreased number of plies.

7. The device of claim 6, wherein the sheath is made from a metal selected from titanium, nickel and alloys thereof.

8. The device of claim 6, wherein the portion proximate the junction of the leading edge and root restores the substantially all the decreased number of plies.

9. The device of claim 8, wherein the decreased number of plies is about 25 mm.

10. The device of claim 9, wherein the decreased number of plies is a decrease from 25 mm to about 0.5 mm and the portion of the sheath proximate the decreased number of plies is from about 12 to 25 mm.

11. A method of strengthening an airfoil comprising the steps of:
providing an airfoil having a composite blade formed from a plurality of plies and having a leading edge and a root for attachment to an engine;
decreasing the number of plies at the junction of the blade leading edge and the root; and
attaching a metallic sheath to the leading edge of the blade, the sheath having a portion proximate the junction of the leading edge and root of sufficient thickness to restore at least a portion of the decreased number of plies.

12. The method of claim 11, wherein the sheath is made from a metal selected from titanium, nickel and alloys thereof.

13. The method of claim 11, wherein the portion proximate the junction of the leading edge and root restores the substantially all the decreased number of plies.

14. The method of claim 13, wherein the decreased number of plies is about 25 mm.

15. The method of claim 14, wherein the decreased number of plies is a decrease from 25 mm to about 0.5 mm and the portion of the sheath proximate the decreased number of plies is from about 12 to 25 mm.
